(19) United States
(12) Patent Application Publication
(10) Pub. No.: US 2005/0096953 A1
(43) Pub. Date: May 5, 2005

(54) Methods and apparatus for predictive service for information technology resource outages

(75) Inventors: Keith Washington, Oak Park, IL (US); Kseniya Mikhaylovna Fuhrman, Shorewood, WI (US); Todd Andrew Golbus, Franklin, WI (US)

Correspondence Address: JAMES D IVEY, 3025 TOTTERDELL STREET, OAKLAND, CA, 94611-1742, US

(73) Assignee: GE Medical Systems Global Technology Co., LLC, Waukesha, WI (US)

(21) Appl. No.: 10/699,269

(22) Filed: Nov. 1, 2003

(51) Int. Cl. G06F 17/60

(52) U.S. Cl. 705/7

(57) ABSTRACT

Methods and apparatus are provided through which a risk profile for a resource of an information technology system is generated from collected infrastructure performance data and collected process data. In some embodiments, the data is correlated from the infrastructure performance data and process data before generation of the risk profile.

### FIELD OF THE INVENTION

This invention relates generally to reliability of information technology systems and applications, and more particularly to predicting outages, failures and errors of resources in the information technology systems and applications.

### BACKGROUND OF THE INVENTION

Reliable information technology systems are often necessary to organizations. Many organizations rely on the operability of their information technology systems to carry out important tasks which are essential to the life of the organization. Information technology systems are essential for organizations to efficiently and effectively manage their organization, fulfill obligations, and satisfy internal and external customers and clients. Information technology systems often include hardware resources such as desktop computer systems, servers and mainframes connected through local area networks, wide area networks and the Internet, and executing software resources such as operating systems, network operating systems, databases, database managers and application programs.

Some conventional efforts for improving the reliability of information technology resources have been directed toward preventing hardware resource failure. For example, fault tolerant computer systems include redundant components of every primary component that takes over for any primary component that fails. Fault tolerant systems also allow failed components to be swapped out with new components while the system is still operational. However, this effort at reducing failures in an information technology system by fault tolerance can be cost prohibitive.

Other conventional efforts in improving the reliability of information technology hardware resources have been directed toward enhancing the reliability of the hardware components and reducing the mean-time-to-repair (MTTR). Efforts at improving the reliability of information technology software resources have been directed towards software development and software testing. These efforts have yielded great improvements in the reliability of information technology resources. However, these efforts have achieved limited isolated increases in stability and are not synergistic to the advancement and stability for other parts of the information technology systems.

Conventional tools that attempt to predict reliability and failure of resources in information technology systems use statistical analysis. Regression analysis is one conventional statistical method of attempting predictions of failure of a resource. In the case of hardware resources, the conventional software tools use only measurements of performance of the hardware resources to attempt to predict the reliabilty and failure of hardware resources. Different tools monitor different attributes, but typically use measurements from only attribute to determine reliability. Furthermore, the conventional software tools are limited to gathering and using past performance of the hardware resources to predict the reliabilty and failure of a hardware resource. This narrow inquiry using a single attribute of past performance as a potential leading indicator of failure of a resource has not provided sufficiently accurate predictions of the reliability of information technology systems.

For the reasons stated above, and for other reasons stated below which will become apparent to those skilled in the art upon reading and understanding the present specification, there is a need in the art for more accurate predictions of reliability and failure of information technology resources. There is also a need for improved availability of information technology resources with less disruption in the operations of organizations by the failure of the information technology resources.

### BRIEF DESCRIPTION OF THE INVENTION

The above-mentioned shortcomings, disadvantages and problems are addressed herein, which will be understood by reading and studying the following specification.

A risk profile for resources of an information technology system is generated from multiple points that include infrastructure performance data and process data of the resources. In some embodiments, the data for the resource is correlated from the infrastructure performance data and process data before generation of the risk profile. In some embodiments, the risk profile comprises a singular quantitative risk score of the resource.

The embodiments take into account a greater breadth of factors that can affect performance or availability of information technology resources. The embodiments have the technical effect of providing more accurate predictions of reliability and failure of information technology resources. The more accurate predictions has the technical effect of allowing failures to be more easily prevented which has the technical effect of providing improved availability of information technology resources with less disruption of the operations of organizations by the failure of the information technology resources.

Systems, clients, servers, methods, and computer-accessible media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of the hardware and operating environment in which different embodiments can be practiced;

FIG. 2 is a diagram illustrating a system-level overview of an embodiment of an information-technology-resource failure-predictor;

FIG. 3 is a flowchart of a method for managing outages of information technology resources in an information technology system;

FIG. 4 is a flowchart of a method for generating a risk profile of information technology resources in an information technology system;

FIG. 5 is a flowchart of a method for generating a risk profile of information technology resources in an information technology system;

FIG. 6 is a flowchart of a method for heuristically adapting an information-technology-resource failure-predictor;

FIG. 7 is a block diagram of an information technology system that includes components that predicts the reliability of resource in the system;

FIG. 8 is a diagram of closely related resources in an information technology system in which different embodiments can be practiced;

FIG. 9 is a block diagram of an implementation of a hardware and operating environment in which different embodiments can be practiced; and

FIG. 10 is a diagram of a graphical depiction of a transfer equation of a risk analysis of infrastructure performance data and process data of a resource.

### DETAILED DESCRIPTION OF THE INVENTION

In the following detailed description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The detailed description is divided into five sections. In the first section, the hardware and the operating environment in conjunction with which embodiments may be practiced are described. In the second section, a system level overview is presented. In the third section, methods for an embodiment are provided. In the fourth section, particular implementations are described. Finally, in the fifth section, a conclusion of the detailed description is provided.

### Hardware and Operating Environment

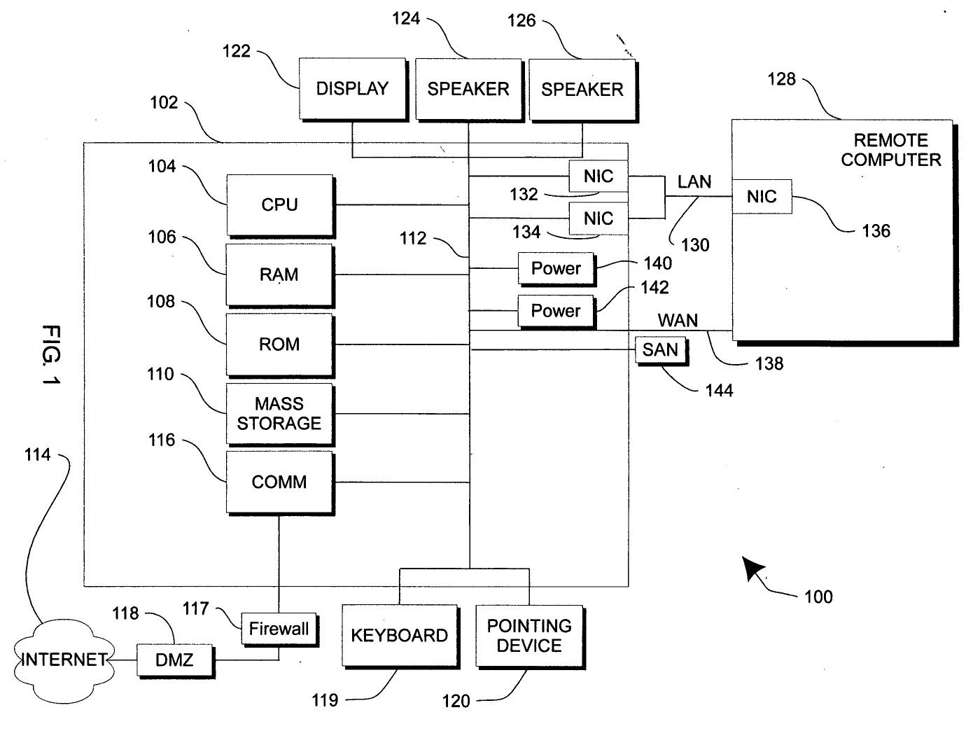

FIG. 1 is a block diagram of the hardware and operating environment 100 in which different embodiments can be practiced. The description of FIG. 1 provides an overview of computer hardware and a suitable computing environment in conjunction with which some embodiments can be implemented. Embodiments are described in terms of a computer executing computer-executable instructions. However, some embodiments can be implemented entirely in computer hardware in which the computer-executable instructions are implemented in read-only memory. Some embodiments can also be implemented in client/server computing environments where remote devices that perform tasks are linked through a communications network. Program modules can be located in both local and remote memory storage devices in a distributed computing environment.

Computer 102 includes a processor 104, commercially available from Intel, Motorola, Cyrix and others. Computer 102 also includes random-access memory (RAM) 106, read-only memory (ROM) 108, and one or more mass storage devices 110, and a system bus 112, that operatively couples various system components to the processing unit 104. The memory 106, 108, and mass storage devices, 110, are types of computer-accessible media. Mass storage devices 110 are more specifically types of nonvolatile computer-accessible media and can include one or more hard disk drives, floppy disk drives, optical disk drives, and tape cartridge drives. The processor 104 executes computer programs stored on the computer-accessible media.

Computer 102 can be communicatively connected to the Internet 114 via a communication device 116 through a firewall device 117 and a demilitized zone (DMZ) 118. The DMZ 118 includes reverse proxies and load balancers. Internet 114 connectivity is well known within the art. In one embodiment, a communication device 116 is a modem that responds to communication drivers to connect to the Internet via what is known in the art as a “dial-up connection.” In another embodiment, a communication device 116 is an Ethernet® or similar hardware network card connected to a local-area network (LAN) that itself is connected to the Internet via what is known in the art as a “direct connection” (e.g., T1 line, etc.). In some embodiments, the firewall device 117 is a software component that is executed by CPU 104.

A user enters commands and information into the computer 102 through input devices such as a keyboard 119 or a pointing device 120. The keyboard 119 permits entry of textual information into computer 102, as known within the art, and embodiments are not limited to any particular type of keyboard. Pointing device 120 permits the control of the screen pointer provided by a graphical user interface (GUI) of operating systems such as versions of Microsoft Windows®. Embodiments are not limited to any particular pointing device 120. Such pointing devices include mice, touch pads, trackballs, remote controls and point sticks. Other input devices (not shown) can include a microphone, joystick, game pad, satellite dish, scanner, or the like.

In some embodiments, computer 102 is operatively coupled to a display device 122. Display device 122 is connected to the system bus 112. Display device 122 permits the display of information, including computer, video and other information, for viewing by a user of the computer. Embodiments are not limited to any particular display device 122. Such display devices include cathode ray tube (CRT) displays (monitors), as well as flat panel displays such as liquid crystal displays (LCD's). In addition to a monitor, computers typically include other peripheral input/output devices such as printers (not shown). Speakers 124 and 126 provide audio output of signals. Speakers 124 and 126 are also connected to the system bus 112.

Computer 102 also includes an operating system (not shown) that is stored on the computer-accessible media RAM 106, ROM 108, and mass storage device 110, and is and executed by the processor 104. Examples of operating systems include Microsoft Windows®, Apple MacOS®, Linux®, UNIX®. Examples are not limited to any particular operating system, however, and the construction and use of such operating systems are well known within the art.

Embodiments of computer 102 are not limited to any type of computer 102. In varying embodiments, computer 102 comprises a PC-compatible computer, a MacOS®-compatible computer, a Linux®-compatible computer, or a UNIX®-compatible computer. The construction and operation of such computers are well known within the art.

Computer 102 can be operated using at least one operating system to provide a graphical user interface (GUI) including a user-controllable pointer. Computer 102 can have at least one web browser application program executing within at least one operating system, to permit users of computer 102 to access intranet or Internet world-wide-web pages as addressed by Universal Resource Locator (URL) addresses. Examples of browser application programs include Netscape Navigator® and Microsoft Internet Explorer®.

The computer 102 can operate in a networked environment using logical connections to one or more remote computers, such as remote computer 128. These logical connections are achieved by a communication device coupled to, or a part of, the computer 102. Embodiments are not limited to a particular type of communications device. The remote computer 128 can be another computer, a server, a router, a network PC, a client, a peer device or other common network node. The logical connections depicted in FIG. 1 include a local-area network (LAN) 130 and a wide-area network (WAN) 132. Such networking environments are commonplace in offices, enterprise-wide computer networks, intranets and the Internet.

When used in a LAN-networking environment, the computer 102 and remote computer 128 are connected to the local network 130 through network interfaces or adapters 132 and 134, which is one type of communications device 116. Network interface 132 is a primary network interface and network interface 134 is fail-over device that provides redundancy in the event of the failure of network interface 132. Remote computer 128 also includes a network device 138. When used in a conventional WAN-networking environment, the computer 102 and remote computer 128 communicate with a WAN 138 through modems (not shown). The modem, which can be internal or external, is connected to the system bus 112. In a networked environment, program modules depicted relative to the computer 102, or portions thereof, can be stored in the remote computer 128.

Computer 102 also includes power supplies 140 and 142. Each power supply can be a battery. Power supply 142 is a failover redundant device to power supply 140. In some embodiments, computer 102 is also operably coupled to a storage area network device (SAN) 144 which is a high-speed network that connects multiple storage devices so that the multiple storage devices may be accessed on all servers in a LAN such as LAN 130 or a WAN such as WAN 138.

### System Level Overview

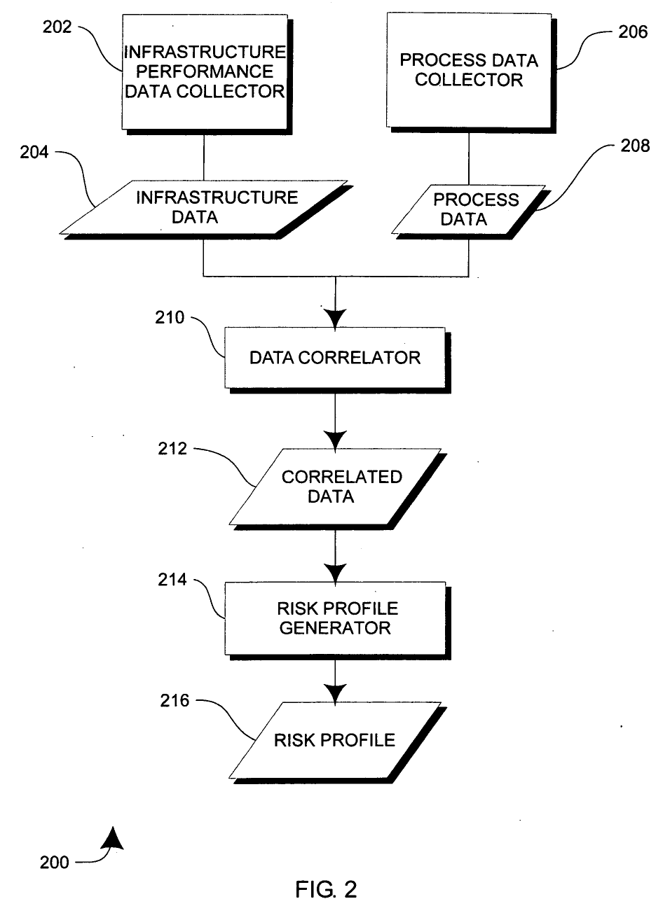

FIG. 2 is a block diagram that provides a system level overview of an information-technology-resource failure-predictor. Embodiments are described as operating in a multi-processing, multi-threaded operating system on a computer, such as computer 102 in FIG. 1. System 200 has the technical effect of providing for improved predictions of reliability and failure of information technology resources. The improved predictions allows a potentially problematic information technology resource to be repaired before the resource fails, thus improving the availability of information technology resource and decreasing disruption in the operations of organizations that rely on the information technology resource. The

System 200 includes a collector 202 of the infrastructure performance data 204 and a collector 206 of the process data 208. In some embodiments, the infrastructure performance data 204 is output from an infrastructure performance measurement tool (not shown). The infrastructure performance data 204 describes the performance of hardware and/or software resources in an information technology system. In some embodiments, the process data 208 is output from a manual-work-process tracking system (not shown), such as a software change control system.

System 200 also includes a data correlator 210 of the infrastructure performance data 204 and process data 208 that produces correlated data 212. The correlator 210 correlates the infrastructure performance data 204 and the process data 208 for individual resources. Thus, activity associated with each resource is readily identifiable across the entire information technology system, thus providing a more thorough, heterogeneous and diverse analysis of the activity of each resource.

System 200 also includes a risk profile generator 214 that receives the correlated data 212, performs a risk analysis on the correlated data 212, and outputs a risk profile 216 of the resource.

The system level overview of the operation of an embodiment has been described in this section of the detailed description. System 200 generates a risk profile 216 of one or more resources from the infrastructure performance data 204 and the process data 208. While the system 200 is not limited to any particular information technology system, infrastructure performance data collector 202, infrastructure performance data 204, process data collector 206, process data 208, correlator 210, correlated data 212, risk profile generator 214 and risk profile 216, for sake of clarity, a simplified infrastructure performance data collector 202, infrastructure performance data 204, process data collector 206, process data 208, correlator 210, correlated data 212, risk profile generator 214 and risk profile 216 have been described.

### Methods of an Embodiment

In the previous section, a system level overview of the operation of an embodiment was described. In this section, particular methods performed by a computer of such an embodiment are described by reference to a series of flowcharts. Describing the methods by reference to a flowchart enables one skilled in the art to develop such programs, firmware, or hardware, including such instructions to carry out the methods on suitable computers executing the instructions from computer-accessible media. Methods 300-600 are performed by a program executing on, or performed by firmware or hardware that is a part of, a computer, such as computer 102 in FIG. 1.

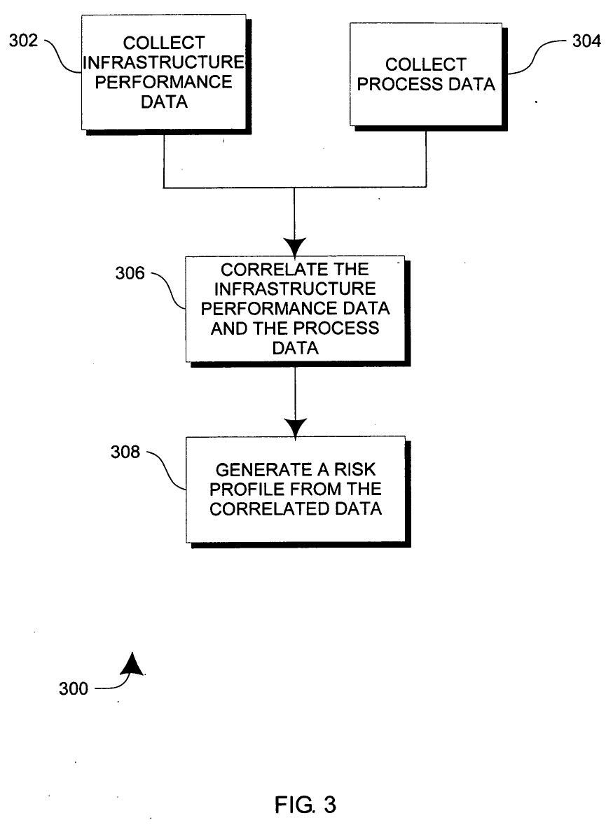

FIG. 3 is a flowchart of a method 300 for managing outages of information technology resources in an information technology system. Method 300 is performed by a computer according to an embodiment. Method 300 has the technical effect of providing for improved availability and failure predictions for information technology resources. The improved predictions allow an information technology resource that appears to be headed for serious interruptions to be taken off-line and repaired on a more timely basis, thus improving the availability of the information technology resource and decreasing disruption in the operations of organizations that rely on the information technology resource.

Method 300 includes collecting infrastructure performance data 302. Infrastructure performance data is collected from at least one infrastructure performance measurement tool, such as an automated testing tool. In some embodiments, the infrastructure performance data further comprises server error log data, application post mortem data. In some embodiments, the infrastructure performance further comprises data describing availability of a resource, response of a resource, application performance, and/or frequency of outages of a resource. The infrastructure performance data is historical and/or real-time data. In some embodiments, the infrastructure performance data includes data of a particular computer resource, such as computer 102, that includes data describing disk space usage, peak and average processor usage, memory usage, up/down status (i.e. heartbeat) data, and warning status based on thresholds of the computer resource. Examples of infrastructure performance measurement tools include Mercury Interactive's Topaz®, Hewlett-Packard's Openview®, and Concord Communications' Network Health®. In some embodiments collecting infrastructure performance data 302 is performed by collector 202 in FIG. 2.

Method 300 also includes collecting process data 304. In some embodiments, process data includes data from a manual-work-process tracking system, such as a change control system, a root-cause analysis system, and/or a service-level control system. Change control systems record manual changes that have been performed on resources. For example, software change control systems record changes that have been made to source code and/or executable code, the date of the change, the human progenitor of the change, and/or identification of the resource or subcomponents of the resource that have been changed. Furthermore, software change control systems also provide a version numbering scheme that indicates which versions of a file are more recent. Software change control systems also allow retrieval of previous versions of a file. Examples of software change control systems include Source Code Control System® (SCCS) that operates in UNIX®, and Cybermation Corporation's ESP Alchemist®. Root-cause analysis systems identify an originating, primary cause of a recurring problem in an information technology system. Root-cause analysis systems identify the root cause of failures as belonging to categories such as a user-related issue, a change control system issue, a hardware failure issue, and a capacity (e.g. load or volume) issue. An example of a root-cause analysis system for information technology systems is Infosys Corporation's Enterprise Management System®. Service-level agreement control systems provide a language and metrics to document user expectations and service agreements. The process data is historical and/or real-time data. In some embodiments, collecting process data 304 is performed by process data collector 206 in FIG. 2.

Manual modification of resources in information technology systems can have a large impact on the reliability of the resources. Thus, collecting data from both an infrastructure performance measurement tool in 302 and a manual-work-process tracking system in 304 allows a more thorough, heterogeneous and diverse analysis of the reliability of the resources. The more thorough analysis allows a more accurate analysis of the current state of resources in a system. The more accurate analysis allows an information technology resource that appears to be headed for serious interruptions to be taken off-line and improved, thus improving the availability of the information technology resource in the long run, and decreasing disruption in the operations of organizations that rely on the information technology resource.

Collecting infrastructure performance data 302 and collecting process data 304 may be performed in any order, or concurrently. For example, collecting infrastructure performance data 302 may be performed before, during, or after collecting process data 304. The order that collecting 302 and 304 is performed is inconsequential, as long as the data is collected before subsequent actions of the method 300 are performed.

Method 300 thereafter includes correlating the infrastructure performance data and the process data 306. The infrastructure performance data and the process data are correlated for particular, specific, individual resources in the information technology system. In the correlating 306, associations for individual resources between the infrastructure performance data and the process data are determined. In some embodiments, correlating 306 is performed by data correlator 210 in FIG. 2. The correlating 306 allows data from the infrastructure performance data and the process data for a resource to be aggregated, thus providing a more thorough, heterogeneous and diverse analysis of a resource.

Correlating 306 in one embodiment is performed in reference to common data object. In each information technology system, a particular resource is identified by a common name in the common data object. In correlating 306, data associated with the common name of each information technology resource is aggregated between various data sources of the infrastructure performance data and the process data.

Method 300 thereafter includes generating a risk profile from the correlated data 308. The risk profile indicates the extent of predicted reliability of one or more resources in the information technology system. In some embodiments, trend or regression analysis on the correlated data is used to provide information on the predicted behavior of a particular resource. In that embodiment, an increasing frequency of outages indicates an increased risk of failure and/or error in the future for the resource. For example, an application that is normally operating 99.2% of the time, and has experienced a period of operating 98.4% of the time will be scored as more risky since the trend is that of more risk for outages for the application.

In some embodiments, the risk profile includes a risk score for each of the information technology resources based on a frequency of outages in the infrastructure performance data and a frequency of changes in the process data. In some embodiments, generating a risk profile 308 is performed by the risk profile generator 214 in FIG. 2.

In some embodiments, the risk score is a Z score, which is a measure of the distance in standard deviations of a sample from the mean. The Z score for a resource indicates how far and in what direction, that a measurement of a resource deviates from the mean measurement of the resource, expressed in units of its standard deviation. The mathematics of the Z score transformation are such that if a Z score for every measurement of a resource is calculated, the Z scores will necessarily have a mean of zero and a standard deviation of one. Z scores are sometimes called “standard scores.” The Z score transformation is also useful when seeking to compare the relative standings of resources with different means and/or different standard deviations. Z scores are also informative when the set of measurements to which they refer, has a normal distribution. In every normal set of measurements, the distance between the mean and a given Z score cuts off a fixed proportion of the total area under the curve. Z scores are also known as transformation functions. In financial management arts, Z scores are used in determining credit worthiness and the possibility or risk of bankruptcy in the future for a person or organization.

Formula 1 shows a formula for the calculation of a Z score:

$$z = \frac{x - \overline{x}}{s} \qquad Formula 1$$

In Formula 1, x is a measurement value of a resource, \overline{x} is a mean of measurements of the resource, and s is a standard deviation of the measurements of the resource. A larger positive Z score indicates a greater risk of failure of the resource, and a larger negative Z score indicates a lesser risk of failure.

Predicting risk based on data from infrastructure performance data collected in 302 and the process data collected in 304 for a resource has the technical effect of providing a more accurate prediction of the expected reliability of the resource. A more accurate prediction of the reliability of a resource allows the resource to be taken off-line and repaired on a more timely basis, thus improving the availability of an information technology resource and decreasing disruption in the operations of organizations that rely on the information technology resource.

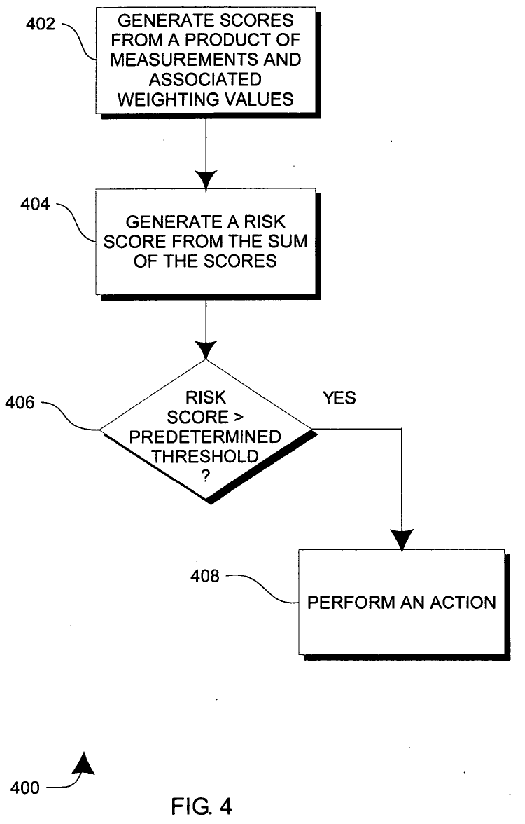

FIG. 4 is a flowchart of a method 400 for generating a risk profile of information technology resources in an information technology system. Method 400 is performed by a computer according to an embodiment. Method 400 is one embodiment of generating a risk profile 308 in FIG. 3. Method 400 has the technical effect of providing a singular, cohesive, risk score for each resource. The singular risk score succinctly quantifies a risk analysis of each resource.

Method 400 implements the formula described in Formula 2 below:

$${\sum }_{i = 1}^{n} {ω}_{i} {χ}_{i} = {ω}_{i} {χ}_{1} + {ω}_{2} {χ}_{2} + {ω}_{3} {χ}_{3} + … + {ω}_{n} {χ}_{n} \qquad Formula 2$$

In Formula 2, ω is a weighing value also known as a weighting factor, and χ is a measurement value. Method 400 includes generating a score for each of the measurements 402 from the ω weighing value and from the χ measurement value. In action 402, each measurement χ is multiplied by a weighting value ω that is associated with each measurement χ. Action 402 yields a plurality of scores. Method 400 thereafter includes summing the plurality of scores 404, yielding a singular, cohesive, risk score for each resource. The singular risk score succinctly quantifies a risk analysis of each resource. The singular risk score has the technical effect of providing a convenient and objective description of the risk of failure in the resource.

In some embodiments, measurements from a variety of dependency resources are summed in action 404. For example, where a risk score of an application is determined in method 400, the measurements and weighting values for each of the resources that the application is dependent upon are included in action 402 and summed in accordance with action 404. Examples of the dependency resources that the application resource is dependent upon include the computer that the application executes on, a firewall that the computer is operably coupled to, a database manager that the application accesses, and the database that the database manager accesses. In those examples, the measurement χ for the computer, firewall, database manager and database resources are multiplied by a weighting value ω for each resource, and the products are summed to determine the risk score of the application.

In some embodiments, the risk score is used to perform and action when the risk score exceeds a predetermined threshold of risk. The risk score is compared to a predetermined numerical value 406. If the risk score is greater than the value, then an action is performed 408, such as providing an alert in the form of a notice to a user. The alert assists a human in recognizing an unacceptable level of risk of failure or error in a resource, thus the human can more effectively plan for repair and maintenance of the resource. As a result, the availability of the resource is improved, and an organization that relies on the resource as a part of an information technology system will have fewer interruptions in their operations.

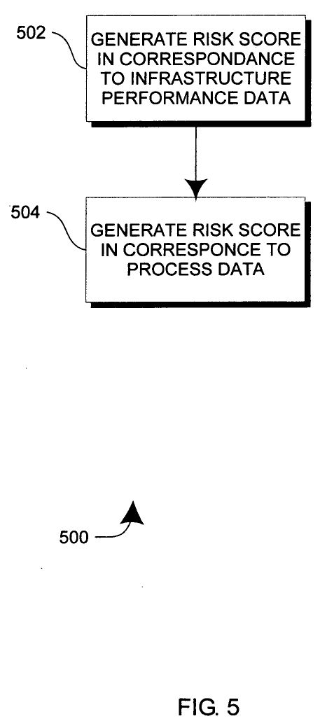

FIG. 5 is a flowchart of a method 500 for generating a risk profile of information technology resources in an information technology system. Method 500 is performed by a computer according to an embodiment. Method 500 is one embodiment of generating a risk profile 308 in FIG. 3. In method 500, a risk score is generated that corresponds in magnitude to the frequency of activity indicated in the infrastructure performance data and the process data. Method 500 has the technical effect of providing a singular, cohesive, risk score for each resource. The singular risk score succinctly quantifies a risk analysis of each resource.

Method 500 includes generating a singular risk score for an information technology resource in correspondence to the frequency of activity, such as outages, as indicated in the infrastructure performance data of the resource 502. Decreasing frequency of outages indicates less risk in the future, and increasing frequency of outages indicates increasing risk in the future. Therefore, in some embodiments, action 502 includes generating the risk score with a higher magnitude for an increasing frequency of outages of the resource as indicated in the infrastructure performance data. In some embodiments, action 502 includes generating the score with a lower magnitude for a decreasing frequency of outages of the resource as indicated in the infrastructure performance data.

Method 500 also includes generating the singular risk score for the resource in correspondence to the frequency of activity, such as changes, as indicated in the process data of the resource 504. Decreasing frequency of change indicates less risk in the future, and increasing frequency of changes indicates increasing risk in the future. Therefore, in some embodiments, action 504 includes generating the score with a higher magnitude for an increasing frequency of changes. In some embodiments, action 504 includes generating the score with a lower magnitude for a decreasing frequency of changes of the resource.

Generating a risk score in correspondence to infrastructure performance data 502 and generating the risk score in correspondence to process data 504 may be performed in any order, or concurrently. For example, generating a risk score in correspondence to infrastructure performance data 502 may be performed before, during, or after generating the risk score in correspondence to process data 504. The order that generating 502 and 504 is performed is inconsequential.

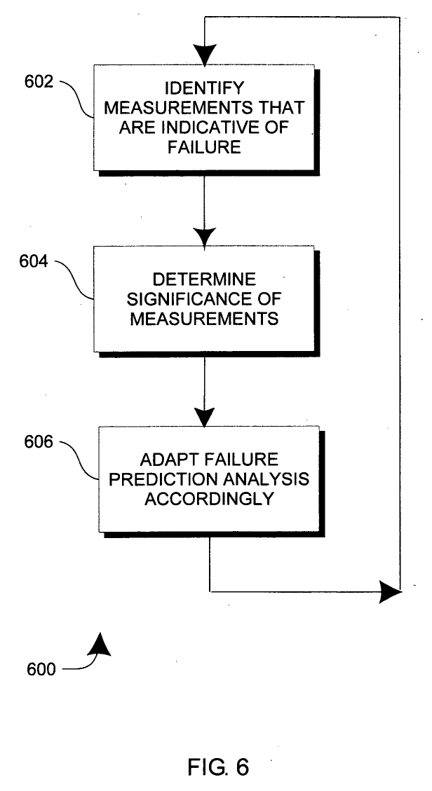

FIG. 6 is a flowchart of a method for heuristically adapting an information-technology-resource failure-predictor. Method 600 is performed by a computer according to an embodiment. In method 600, failure prediction analysis is adapted based on failure experiences to improve the results of the failure prediction.

Method 600 includes identifying measurements in the infrastructure data and the process data that are indicative of failure rates of resources 602. Method 600 also includes determining the significance of each of the measurements 604. Thereafter, a method for calculating risk is modified accordingly 606. Examples of methods include methods 300-500. For example, Formula 2 supra is modified with a set of weighing values ω in accordance with the significance of the measurements and the measurement values χ are modified in accordance with the measurements that are indicative of failure rates. Method 600 is performed periodically and indefinitely in order to heuristically update failure prediction analysis.

In some embodiments, methods 300-600 are implemented as a computer data signal embodied in a carrier wave, that represents a sequence of instructions which, when executed by a processor, such as processor 104 in FIG. 1, cause the processor to perform the respective method. In other embodiments, methods 300-600 are implemented as a computer-accessible medium having executable instructions capable of directing a processor, such as processor 104 in FIG. 1, to perform the respective method. In varying embodiments, the medium is a magnetic medium, an electronic medium, or an optical medium.

### Implementation

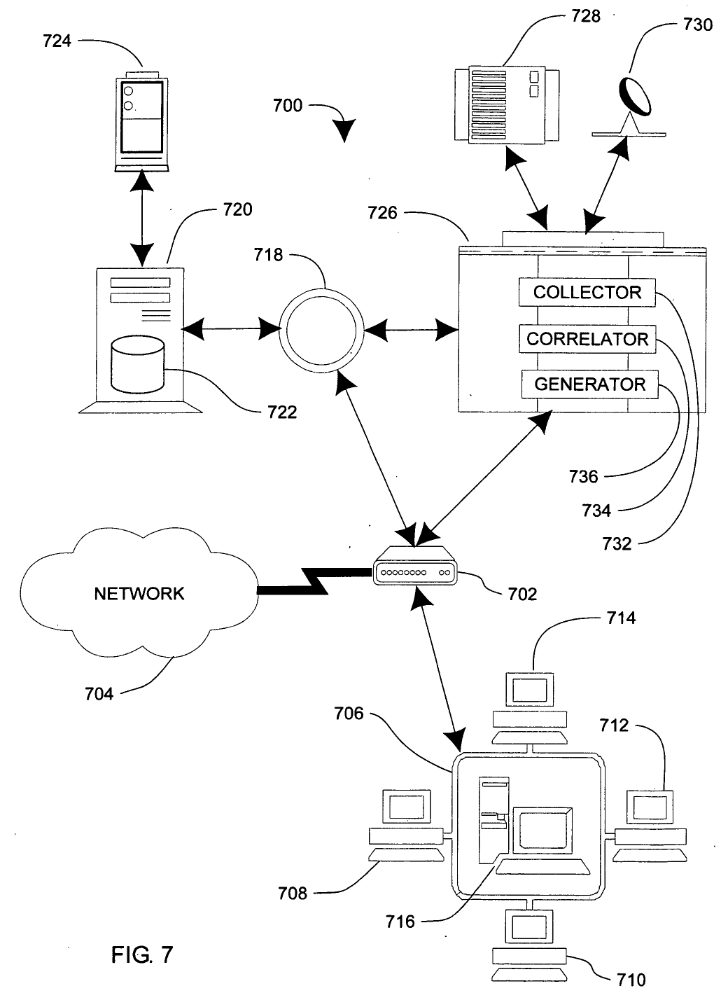

Referring to FIGS. 7-10, particular implementations are described in conjunction with the system overview in FIG. 2 and the methods described in conjunction with FIGS. 3-6.

FIG. 7 is a block diagram of an information technology system 700 that includes components that predict the reliability of a resource in the system. Information technology system 700 includes a router 702 that exchanges data with a network 704, such as the Internet. The router 702 is operably coupled to a local area network 706, that is in turn operably coupled to a number of personal computers, 708, 710, 712, and 714, such as computer 102 in FIG. 1. The LAN 706 has a server 716.

The router 702 is also operably coupled to a wide-area network (WAN) 718. The WAN 718 is operably coupled to a server 720 having a database 722 and a database manager (not shown). The server 720 is also operably coupled to a backup tape device 724.

Information technology system 700 also includes a mainframe computer 726 that is operably coupled to the router 702 and the WAN 718. The mainframe computer 726 is in turn operably coupled to a disk array 728 and a satellite communication device 730.

In some embodiments, the mainframe computer 726 includes a data collector 732 that is substantially similar to the infrastructure performance data collector 202 and the process data collector 206 in FIG. 2. The collector 732 collects infrastructure performance data (not shown) and process data (not shown), such as infrastructure performance data and process data 210 in FIG. 2. The data is collected from at least one of the resources in the information technology system 700. All of the hardware and software components and communication links in information technology system 700 are resources. In some embodiments, the data collector 732 performs actions such as collecting infrastructure performance data 302 and/or collecting process data 304 in FIG. 3.

In some embodiments, the mainframe computer 726 includes a correlator 734 that is substantially similar to the data correlator 210 in FIG. 2. The correlator 734 correlates data within the infrastructure performance data (not shown) and process data (not shown) for one or more particular resource. In some embodiments, the correlator 734 performs the action of correlating the infrastructure performance data and the process data 306 in FIG. 3.

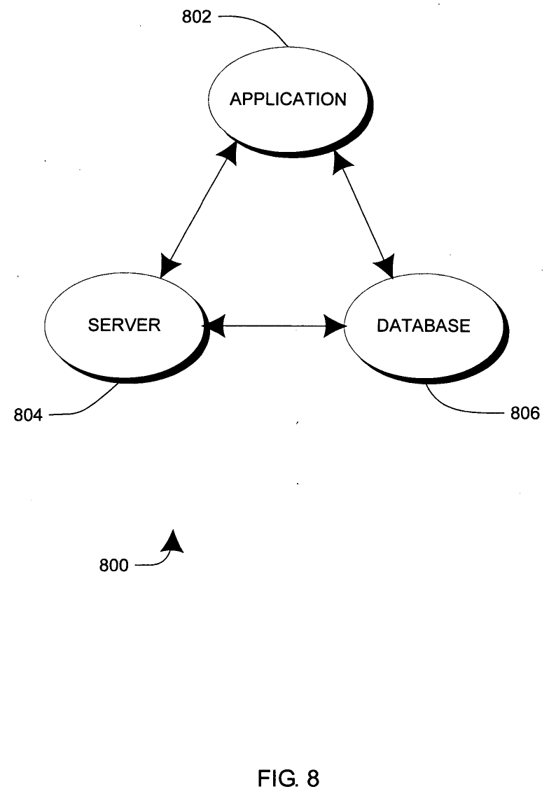

In other embodiments, the correlator 734 correlates data for closely related resources from the infrastructure performance data and the process data, such as application data, server data and database data. Correlating the application data, server data and database data allows the interaction of closely related resources to be analyzed together, allowing a risk analysis that has the technical effect of providing predictions on closely related resources. Correlating the application data, server data and database data is described further in FIG. 8.

In yet other embodiments, the correlator 734 correlates the infrastructure performance data and the process data for each of the information technology resources, in reference to organizational control of the resources. Correlating data in reference to organizational control of the resources allows a risk analysis that has the technical effect of providing predictions of the expected performance and reliability of resources that are relied upon by a particular organization. The organization may be a portion of a larger organization, such as a division, a project or a department. In some embodiments, correlating data in reference to organizational control is performed in reference to a common data object that identifies which organization owns and/or modifies a resource.

In some embodiments, the mainframe computer 726 includes a risk profile generator 736 that is substantially similar to the risk profile generator 214 of FIG. 2. In some embodiments, risk profile generator 736 generates a risk profile from the correlated data 308 in FIG. 3. In some other embodiments, the risk profile generator 736 performs the method 400 in FIG. 4 and/or method 500 in FIG. 5. In other embodiments, data collector 732, correlator 734, and/or risk profile generator 736 are included personal computers 708, 710, 712, and 714, and/or servers 716 and 720.

System 700 takes into account a greater breadth of factors, including process data, that can affect performance or availability of information technology resources. Thus, system 700 has the technical effect of providing an assessment of risk in the failure or error of operation of information technology resources that is based on a more comprehensive analysis of the resources. The more comprehensive analysis results in a more accurate analysis, which assists an administrator of the information technology system 700 in planning repair and maintenance of the resources.

FIG. 8 is a diagram of closely related resources 800 in an information technology system in which different embodiments can be practiced. The closely related resources are an application 802, a server 804 and a database 806. Correlating application data, server data and database data allows the interaction of closely related resources to be analyzed together, allowing a risk analysis that has the technical effect of providing predictions of the behavior and the reliability of closely related resources.

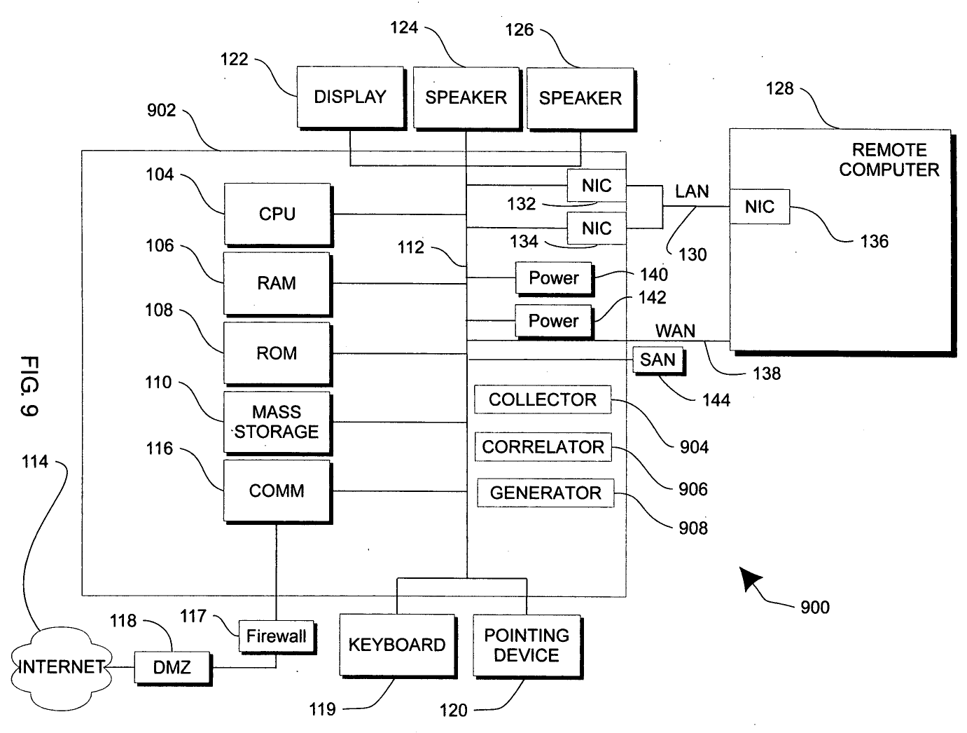

FIG. 9 is a block diagram of an implementation of a hardware and operating environment 900 in which different embodiments can be practiced. FIG. 9 depicts a computer 902 that includes embodiments of components that collect data, correlate the data and analyze the data.

In some embodiments, the computer 902 includes a data collector 904 that is substantially similar to the infrastructure performance data collector 202 and the process data collector 206 in FIG. 2, and the collector 732 in FIG. 7. In some embodiments, data collector 904 performs collecting infrastructure performance data 302 and/or collecting process data 304 in FIG. 3.

In some embodiments, the computer 902 includes a correlator 906 that is substantially similar to the data correlator 210 in FIG. 2 and the correlator 734 in FIG. 7. In some embodiments, the correlator 906 performs the action of correlating the infrastructure performance data and the process data 306 in FIG. 3. The correlator 734 correlates data within the infrastructure performance data (not shown) and process data (not shown) for one or more resources.

In some embodiments, the mainframe computer 902 includes a risk profile generator 908 that is substantially similar to the risk profile generator 214 of FIG. 2 and generator 736 in FIG. 7. In some embodiments, risk profile generator 908 generates a risk profile from the correlated data 308 in FIG. 3. In some other embodiments, the risk profile generator 908 performs the method 400 in FIG. 4 and/or method 500 in FIG. 5.

Computer 902 can be implemented in any one of the computers in FIG. 7, such as personal computers 708, 710, 712, and 714, servers 716 and 720, and mainframe 726. Thus, computer 902 allows the risk of at least one of the resources in an information technology system to be evaluated with a greater degree of accuracy.

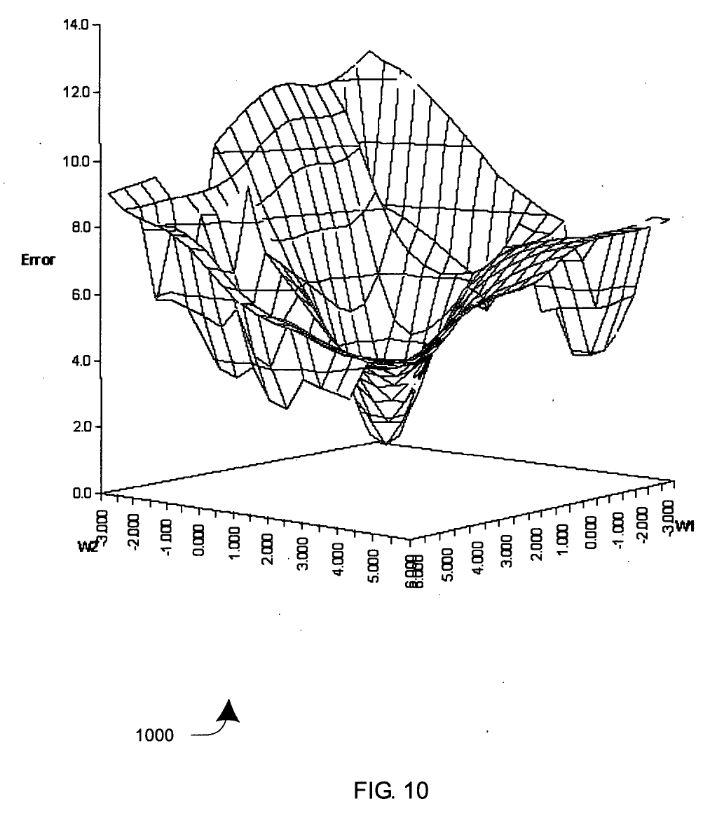

FIG. 10 is a diagram 1000 of a graphical depiction of a transfer equation of a risk analysis of infrastructure performance data and process data of a resource. The risk analysis uses the formula of risk analysis that is described in FIG. 4 and shown in Formula 2. The formula in Formula 2 is used to produce numerical descriptions of the risk for a resource. The numerical descriptions of risk are displayed graphically, as in FIG. 10.

In the example of diagram 1000, the horizontal axes plot the weighting factors W₁ and W₂, and the magnitude of the risk of error by the resource is plotted along the vertical axis. Thus, diagram 1000 allows the risk of error in the resource to be easily and quickly reviewed by a human. Diagram 1000 provides information that is used by a human to anticipate failures in the resource, and plan for repair and maintenance of the resource. Thus the availability of the resource is improved, and an organization that relies on the resource as part of the information technology system will have fewer interruptions in their operations.

The system components of the database 722, database manager (not shown), data collector 732, correlator 734, risk profile generator 736, application 802, a server 804, a database 806, data collector 904, correlator 906, and risk profile generator 908 can be embodied as computer hardware circuitry or as a computer-accessible program, or a combination of both. Some embodiments can also be implemented in client/server computing environments where remote devices that perform tasks are linked through a communications network. In another embodiment, system 800 is implemented in an application service provider (ASP) system.

More specifically, in the computer-accessible program embodiment, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer 102 in FIG. 1, or each component can be performed on a separate computer. Program modules can be located in both local and remote memory storage devices in a distributed computing.

### Conclusion

An information-technology-resource failure-predictor has been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations. For example, although described in procedural design terms, one of ordinary skill in the art will appreciate that implementations can be made in an object-oriented design environment or any other design environment that provides the required relationships.

In particular, one of skill in the art will readily appreciate that the names of the methods and apparatus are not intended to limit embodiments. Furthermore, additional methods and apparatus can be added to the components, functions can be rearranged among the components, and new components to correspond to future enhancements and physical devices used in embodiments can be introduced without departing from the scope of embodiments. One of skill in the art will readily recognize that embodiments are applicable to future communication devices, different file systems, and new data types.

The terminology used in this application with respect to information technology systems, databases, servers, application programs and communication environments is meant to include all information technology system, database, server, application program and communication environments and alternate technologies which provide the same functionality as described herein.

1. A method for managing outages of information technology resources, comprising:
collecting infrastructure performance data;
collecting process data;
correlating the infrastructure performance data and the process data; and
generating a risk profile from the correlated data.

2. The method as in claim 1, wherein collecting infrastructure performance data is performed concurrently with collecting process data.

3. The method as in claim 1, wherein collecting infrastructure performance data further comprises:
collecting infrastructure performance data from at least one automated testing tool, wherein the infrastructure performance data further comprises at least one of application performance data, server error logs, application post mortem data, and outage data.

4. The method as in claim 1, wherein collecting process data further comprises:
collecting process data from at least one manual-work-process tracking system.

5. The method as in claim 4, wherein collecting process data from at least one manual-work-process tracking system further comprises:
collecting process data from at least one change control system.

6. The method as in claim 4, wherein collecting process data from at least one manual-work-process tracking system further comprises:
collecting process data from at least one root-cause analysis system.

7. The method as in claim 4, wherein collecting process data from at least one manual-work-process tracking system further comprises:
collecting process data from at least one service-level control system.

8. The method as in claim 1, wherein the correlating further comprises:
correlating application data, server data and database data from the infrastructure performance data and the process data.

9. The method as in claim 1, wherein the correlating further comprises:
correlating the infrastructure performance data and the process data for each of the information technology resources, in reference to organizational control of the resources.

10. The method as in claim 1, wherein the correlating further comprises:
correlating at least one type of resource data selected from the group consisting of application resource data, server resource data and database resource data, in reference to a common data object.

11. The method as in claim 1, wherein generating a risk profile further comprises:
generating a risk score from a frequency of outages in the infrastructure performance data and a frequency of changes in the process data, for each of the information technology resources.

12. The method as in claim 1, wherein the infrastructure performance data further comprises at least one measurement of performance for an information technology resource and the process data further comprises at least one measurement of activity for the information technology resource, and generating a risk profile further comprises:
generating a score for each of the measurements, each measurement being multiplied by a weighting value associated with each measurement, yielding a plurality of scores; and
summing the plurality of scores, yielding a risk score.

13. The method as in claim 12, wherein generating a score for each of the measurements further comprises:
generating the score with a higher magnitude for an increasing frequency of outages of the information technology resource as indicated in the infrastructure performance data; and
generating the score with a higher magnitude for an increasing frequency of changes of the information technology resource as indicated in the process data.

14. The method as in claim 12, wherein generating a score for each of the measurements further comprises:
generating the score with a lower magnitude for a decreasing frequency of outages of the information technology resource as indicated in the infrastructure performance data; and
generating the score with a lower magnitude for a decreasing frequency of changes of the information technology resource as indicated in the process data.

15. The method as in claim 1, wherein a higher risk score is generated for information technology resources having an increasing frequency of outages.

16. A method for predicting outages of an information technology resource, comprising:
generating a singular risk score from infrastructure performance data of the information technology resource and process data of the information technology resource; and
providing an alert to a user when the singular risk score exceeds a predetermined threshold.

17. The method as in claim 16, wherein a higher singular risk score is generated for an increasing frequency of outages of the information technology resource.

18. The method as in claim 16, wherein generating a singular risk score further comprises:
generating the singular risk score with a higher magnitude for an increasing frequency of outages of the information technology resource as indicated in the infrastructure performance data;
generating the singular risk score with a higher magnitude for an increasing frequency of changes of the information technology resource as indicated in the process data;
generating the singular risk score with a lower magnitude for a decreasing frequency of outages of the information technology as indicated in the infrastructure performance data; and
generating the singular risk score with a lower magnitude for a decreasing frequency of changes of the information technology as indicated in the process data.

19. The method as in claim 16, wherein generating a singular risk score further comprises:
generating the singular risk score in correspondence to the frequency of outages indicated in the infrastructure performance data and in correspondence to the frequency of changes in the process data.

20. The method as in claim 16, wherein the infrastructure performance data further comprises at least one measurement of performance and the process data further comprises at least one measurement of activity, and generating a singular risk score further comprises:
generating a singular score for each of the measurements, each measurement being multiplied by a weighting value associated with each measurement, yielding a plurality of weighted scores; and
summing the plurality of weighted scores, yielding the singular risk score.

21. The method as in claim 16, the method further comprising:
collecting (304) the process data (208) from at least one manual-work-process tracking system;
collecting the infrastructure performance data; and
correlating the infrastructure performance data and the process data.

22. The method as in claim 21, wherein collecting process data from at least one manual-work-process tracking system further comprises:
collecting process data from at least one change control system.

23. The method as in claim 21, wherein collecting infrastructure performance data further comprises:
collecting infrastructure performance data from at least one automated testing tool, and wherein the infrastructure performance data further comprises at least one of application performance data, server error logs, application post mortem data, and outage data.

24. The method as in claim 21, wherein the correlating further comprises:
correlating application data, server data and database data from the infrastructure performance data and the process data.

25. A method for managing data that is predictive of reliability of an information technology system, comprising:
collecting process data associated with at least one information technology resource;
collecting infrastructure performance data associated with the at least one information technology resource; and
correlating the infrastructure performance data and the process data for the information technology resource.

26. The method as in claim 25, wherein collecting infrastructure performance data is performed after collecting process data.

27. The method as in claim 25, wherein collecting infrastructure performance data further comprises:
collecting infrastructure performance data from at least one automated testing tool, wherein the infrastructure performance data further comprises at least one of application performance data, server error logs, application post mortem data, and outage data.

28. The method as in claim 25, wherein collecting process data further comprises:
collecting process data from at least one software-change control system.

29. The method as in claim 25, wherein collecting process data further comprises:
collecting process data from at least one root-cause analysis system.

30. The method as in claim 25, wherein collecting process data from further comprises:
collecting process data from at least one service-level control system.

31. The method as in claim 25, wherein the correlating further comprises:
correlating application data, server data and database data from the infrastructure performance data and the process data.

32. The method as in claim 25, wherein the correlating further comprises:
correlating the infrastructure performance data and the process data for the at least one information technology resource, in reference to organizational control of the resource.

33. The method as in claim 25, wherein the correlating further comprises:
correlating at least one type of resource data selected from the group consisting of application resource data, server resource data and database resource data, in reference to a common data object.

34. The method as in claim 25, the method further comprising:
generating a risk score for each of the at least one information technology resource from the infrastructure performance data and the process data, wherein the magnitude of each risk score is in correspondence to the frequency of outages indicated in the infrastructure performance data and wherein the magnitude of each risk score is in correspondence to the frequency of changes in the process data.

35. The method as in claim 34, wherein the infrastructure performance data further comprises at least one measurement of performance and the process data further comprises at least one measurement of activity, and generating a risk profile further comprises:
generating a plurality of scores by multiplying each measurement with a weighting value associated with each measurement; and
generating a risk score from a sum of the plurality of scores.

36. A method for assessing reliability of a plurality of information technology resources, comprising:
collecting infrastructure data;
collecting process data; and
generating a risk profile for each of the plurality of information technology resources, from the infrastructure data and the process data.

37. The method as in claim 36, wherein collecting process data further comprises:
collecting process data from at least one manual-work-process tracking system.

38. The method as in claim 36, wherein collecting process data from at least one manual-work-process tracking system further comprises:
collecting process data from at least one change control system.

39. The method as in claim 36, wherein collecting process data from at least one manual-work-process tracking system further comprises:
collecting process data from at least one root-cause analysis system.

40. The method as in claim 36, wherein collecting process data from at least one manual-work-process tracking system further comprises:
collecting process data from at least one service-level control system.

41. The method as in claim 36, wherein collecting infrastructure data further comprises:
collecting infrastructure data from at least one automated testing tool.

42. The method as in claim 36, wherein the method further comprises:
correlating the infrastructure data and the process data, and generating a risk profile further comprises:
generating a risk profile from the correlated data.

43. The method as in claim 42, wherein the correlating further comprises:
correlating application data, server data and database data from the infrastructure data and the process data for each of the information technology resources.

44. The method as in claim 36, wherein generating a risk profile further comprises:
generating a risk score from the infrastructure data and the process data, wherein the magnitude of the risk score corresponds to the frequency of outages indicated in the infrastructure data and wherein the magnitude of the risk score corresponds to the frequency of changes in the process data, for each of the plurality of information technology resources.

45. The method as in claim 36, wherein the infrastructure data further comprises at least one measurement of performance for each of the plurality of information technology resources and the process data further comprises at least one measurement of activity for each of the plurality of information technology resources, and generating a risk profile further comprises:
generating a score for each of the at least one measurement, each measurement being multiplied by a weighting value associated with each measurement, yielding at least one score; and
summing the at least one score, yielding a risk score.

46. The method as in claim 45, wherein generating a score further comprises:
generating the score with a higher magnitude for resources having an increasing frequency of outages as indicated in the infrastructure data; and
generating the score with a higher magnitude for resources having an increasing frequency of changes as indicated in the process data.

47. The method as in claim 45, wherein generating a risk score further comprises:
generating the risk score with a lower magnitude for resources having a decreasing frequency of outages as indicated in the infrastructure data; and
generating the risk score with a lower magnitude for resources having a decreasing frequency of changes as indicated in the process data.

48. The method as in claim 36, wherein a higher risk score is generated for resources having an increasing frequency of outages.

49. A computer-accessible medium having executable instructions to manage outages of information technology resources, the executable instructions capable of directing a processor to perform:
collecting infrastructure performance data from at least one automated testing tool, wherein the infrastructure performance data further comprises at least one of application performance data, server error logs, application post mortem data, and outage data;
collecting process data from at least one of a one service-level control system, a change control system, a root-cause analysis system;
correlating the infrastructure performance data and the process data; and
generating a risk profile for each of the information technology resources from a frequency of outages in the correlated data and a frequency of changes in the correlated data.

50. The computer-accessible medium as in claim 49, wherein collecting infrastructure performance data is performed concurrently with collecting process data.

51. The computer-accessible medium as in claim 49, wherein the correlating further comprises:
correlating application data, server data and database data from the infrastructure performance data and the process data.

52. The computer-accessible medium as in claim 49, wherein the correlating further comprises:
correlating the infrastructure performance data and the process data for each of the information technology resources, in reference to organizational control of the resources.

53. The computer-accessible medium as in claim 49, wherein the infrastructure performance data further comprises at least one measurement of performance for an information technology resource and the process data further comprises at least one measurement of activity for the information technology resource, and generating a risk profile further comprises:
generating a score for each of the measurements, each measurement being multiplied by a weighting value associated with each measurement, yielding a plurality of scores; and
summing the plurality of scores, yielding a risk score.

54. The computer-accessible medium as in claim 53, wherein generating a score for each of the measurements further comprises:
generating the score with a higher magnitude for an increasing frequency of outages of the information technology resource as indicated in the infrastructure performance data;
generating the score with a higher magnitude for an increasing frequency of changes of the information technology resource as indicated in the process data;
generating the score with a lower magnitude for a decreasing frequency of outages of the information technology resource as indicated in the infrastructure performance data; and
generating the score with a lower magnitude for a decreasing frequency of changes of the information technology resource as indicated in the process data.

55. A computer-accessible medium having executable instructions to predict outages of an information technology resource, the executable instructions capable of directing a processor to perform:
generating a singular risk score from infrastructure performance data of the information technology resource and process data of the information technology resource; and
providing an alert to a user when the singular risk score exceeds a predetermined threshold.

56. The computer-accessible medium as in claim 55, wherein generating a singular risk score further comprises:
generating the singular risk score in correspondence to the frequency of outages indicated in the infrastructure performance data and in correspondence to the frequency of changes in the process data.

57. The computer-accessible medium as in claim 55, wherein the infrastructure performance data further comprises at least one measurement of performance and the process data further comprises at least one measurement of activity, and generating a singular risk score further comprises:
generating a singular score for each of the measurements, each measurement being multiplied by a weighting value associated with each measurement, yielding a plurality of weighted scores; and
summing the plurality of weighted scores, yielding the singular risk score.

58. The computer-accessible medium as in claim 55, the method further comprising:
collecting (304) the process data (208) from at least one manual-work-process tracking system;
collecting the infrastructure performance data; and
correlating the infrastructure performance data and the process data.

59. The computer-accessible medium as in claim 58, wherein collecting process data from at least one manual-work-process tracking system further comprises:
collecting process data from at least one change control system; and
collecting infrastructure performance data from at least one automated testing tool, and wherein the infrastructure performance data further comprises at least one of application performance data, server error logs, application post mortem data, and outage data.

60. A computer-accessible medium having executable instructions to manage data that is predictive of reliability of an information technology system, the executable instructions capable of directing a processor to perform:
collecting process data associated with at least one information technology resource;
collecting infrastructure performance data associated with the at least one information technology resource; and
correlating the infrastructure performance data and the process data for the information technology resource.

61. The computer-accessible medium as in claim 60, wherein collecting infrastructure performance data further comprises:
collecting infrastructure performance data from at least one automated testing tool, wherein the infrastructure performance data further comprises at least one of application performance data, server error logs, application post mortem data, and outage data, and
wherein collecting process data further comprises:
collecting process data from at least one software-change control system, at least one root-cause analysis system, and at least one service-level control system.

62. The computer-accessible medium as in claim 60, wherein the correlating further comprises:
correlating application data, server data and database data from the infrastructure performance data and the process data, for the at least one information technology resource, and in reference to organizational control of the resource.

63. The computer-accessible medium as in claim 60, wherein the correlating further comprises:
correlating at least one type of resource data selected from the group consisting of application resource data, server resource data and database resource data, in reference to a common data object.

64. The computer-accessible medium as in claim 60, the method further comprising:
generating a risk score for each of the at least one information technology resource from the infrastructure performance data and the process data, wherein the magnitude of each risk score is in correspondence to the frequency of outages indicated in the infrastructure performance data and wherein the magnitude of each risk score is in correspondence to the frequency of changes in the process data.

65. The computer-accessible medium as in claim 64, wherein the infrastructure performance data further comprises at least one measurement of performance and the process data further comprises at least one measurement of activity, and generating a risk profile further comprises:
generating a plurality of scores by multiplying each measurement with a weighting value associated with each measurement; and
generating a risk score from a sum of the plurality of scores.

66. A computer-accessible medium having executable instructions to assess reliability of a plurality of information technology resources, the executable instructions capable of directing a processor to perform:
collecting infrastructure data;
collecting process data from at least one change control system; and
generating a risk profile for each of the plurality of information technology resources, from the infrastructure data and the process data.

67. The computer-accessible medium as in claim 66, wherein collecting infrastructure data further comprises:
collecting infrastructure data from at least one automated testing tool.

68. The computer-accessible medium as in claim 66, wherein the method further comprises:
correlating the infrastructure data and the process data, and generating a risk profile further comprises:
generating a risk profile from the correlated data.

69. The computer-accessible medium as in claim 66, wherein generating a risk profile further comprises:
generating a risk score from the infrastructure data and the process data, wherein the magnitude of the risk score corresponds to the frequency of outages indicated in the infrastructure data and wherein the magnitude of the risk score corresponds to the frequency of changes in the process data, for each of the plurality of information technology resources.

70. The computer-accessible medium as in claim 66, wherein the infrastructure data further comprises at least one measurement of performance for each of the plurality of information technology resources and the process data further comprises at least one measurement of activity for each of the plurality of information technology resources, and generating a risk profile further comprises:
generating a score for each of the at least one measurement, each measurement being multiplied by a weighting value associated with each measurement, yielding at least one score; and
summing the at least one score, yielding a risk score.

71. A computer data signal embodied in a carrier wave and representing a sequence of instructions which, when executed by a processor, cause the processor to perform a method of:
collecting infrastructure performance data from at least one automated testing tool, wherein the infrastructure performance data further comprises at least one of application performance data, server error logs, application post mortem data, and outage data;
collecting process data from at least one of a one service-level control system, a change control system, a root-cause analysis system;
correlating the infrastructure performance data and the process data; and
generating a risk profile for each of the information technology resources from a frequency of outages in the correlated data and a frequency of changes in the correlated data.

72. The computer data signal as in claim 71, wherein the correlating further comprises:
correlating the infrastructure performance data and the process data for each of the information technology resources.

73. The computer data signal as in claim 71, wherein the infrastructure performance data further comprises at least one measurement of performance for an information technology resource and the process data further comprises at least one measurement of activity for the information technology resource, and generating a risk profile further comprises:
generating a score for each of the measurements, each measurement being multiplied by a weighting value associated with each measurement, yielding a plurality of scores; and
summing the plurality of scores, yielding a risk score.

74. A computer data signal embodied in a carrier wave and representing a sequence of instructions which, when executed by a processor, cause the processor to perform a method of:
generating a singular risk score from infrastructure performance data of the information technology resource and process data of the information technology resource; and
providing an alert to a user when the singular risk score exceeds a predetermined threshold.

75. The computer data signal as in claim 74, wherein generating a singular risk score further comprises:
generating the singular risk score in correspondence to the frequency of outages indicated in the infrastructure performance data and in correspondence to the frequency of changes in the process data.

76. The computer data signal as in claim 74, wherein the infrastructure performance data further comprises at least one measurement of performance and the process data further comprises at least one measurement of activity, and generating a singular risk score further comprises:
generating a singular score for each of the measurements, each measurement being multiplied by a weighting value associated with each measurement, yielding a plurality of weighted scores; and
summing the plurality of weighted scores, yielding the singular risk score.

77. The computer data signal as in claim 74, the method further comprising:
collecting (304) the process data (208) from at least one manual-work-process tracking system;
collecting the infrastructure performance data; and
correlating the infrastructure performance data and the process data.

78. A computer data signal embodied in a carrier wave and representing a sequence of instructions which, when executed by a processor, cause the processor to perform a method of:
collecting process data associated with at least one information technology resource;
collecting infrastructure performance data associated with the at least one information technology resource; and
correlating the infrastructure performance data and the process data for the information technology resource.

79. The computer data signal as in claim 78, wherein collecting process data further comprises:
collecting process data from at least one software-change control system, at least one root-cause analysis system, and at least one service-level control system.

80. The computer data signal as in claim 78, wherein the correlating further comprises:
correlating at least one type of resource data selected from the group consisting of application resource data, server resource data and database resource data, in reference to a common data object.

81. The computer data signal as in claim 78, the method further comprising:
generating a risk score for each of the at least one information technology resource from the infrastructure performance data and the process data, wherein the magnitude of each risk score is in correspondence to the frequency of outages indicated in the infrastructure performance data and wherein the magnitude of each risk score is in correspondence to the frequency of changes in the process data, and
wherein the infrastructure performance data further comprises at least one measurement of performance and the process data further comprises at least one measurement of activity, and generating a risk profile further comprises:
generating a plurality of scores by multiplying each measurement with a weighting value associated with each measurement; and
generating a risk score from a sum of the plurality of scores.

82. A computer data signal embodied in a carrier wave and representing a sequence of instructions which, when executed by a processor, cause the processor to perform a method of:
collecting infrastructure data;
collecting process data from at least one change control system; and
generating a risk profile for each of the plurality of information technology resources, from the infrastructure data and the process data.

83. The computer data signal as in claim 82, wherein the method further comprises:
correlating the infrastructure data and the process data, and generating a risk profile further comprises:
generating a risk profile from the correlated data.

84. The computer data signal as in claim 82, wherein generating a risk profile further comprises:
generating a risk score from the infrastructure data and the process data, wherein the magnitude of the risk score corresponds to the frequency of outages indicated in the infrastructure data and wherein the magnitude of the risk score corresponds to the frequency of changes in the process data, for each of the plurality of information technology resources.

85. The computer data signal as in claim 82, wherein the infrastructure data further comprises at least one measurement of performance for each of the plurality of information technology resources and the process data further comprises at least one measurement of activity for each of the plurality of information technology resources, and generating a risk profile further comprises:
generating a score for each of the at least one measurement, each measurement being multiplied by a weighting value associated with each measurement, yielding at least one score; and
summing the at least one score, yielding a risk score.

86. An apparatus comprising:
a collector of infrastructure performance data from at least one automated testing tool, wherein the infrastructure performance data further comprises at least one of application performance data, server error logs, application post mortem data, and outage data;
a collector of process data from at least one of a one service-level control system, a change control system, a root-cause analysis system;
a correlator of the infrastructure performance data and the process data; and
a generator of a risk profile for each of the information technology resources from a frequency of outages in the correlated data and a frequency of changes in the correlated data.

87. The apparatus as in claim 86, wherein the correlator further comprises:
a correlator of the infrastructure performance data and the process data for each of the information technology resources.

88. The apparatus as in claim 86, wherein the infrastructure performance data further comprises at least one measurement of performance for an information technology resource and the process data further comprises at least one measurement of activity for the information technology resource, and the risk profile generator further comprises:
a generator of a score for each of the measurements, each measurement being multiplied by a weighting value associated with each measurement, yielding a plurality of scores; and
an adder of the plurality of scores, yielding a risk score.

89. An apparatus comprising:
a generator of a singular risk score from infrastructure performance data of the information technology resource and process data of the information technology resource; and
a provider of an alert to a user when the singular risk score exceeds a predetermined threshold.

90. The apparatus as in claim 89, wherein generator of the singular risk score further comprises:
a generator of the singular risk score, the score being in correspondence to a frequency of outages indicated in the infrastructure performance data and in correspondence to a frequency of changes in the process data.

91. The apparatus as in claim 89, wherein the infrastructure performance data further comprises at least one measurement of performance and the process data further comprises at least one measurement of activity, and the generator of the singular risk score further comprises:
a generator of a singular score for each of the measurements, each measurement being multiplied by a weighting value associated with each measurement, yielding a plurality of weighted scores; and
an adder of the plurality of weighted scores, yielding the singular risk score.

92. The apparatus as in claim 89, the method further comprising:
a collector of the process data from at least one manual-work-process tracking system;
a collector of the infrastructure performance data; and
a correlator of the infrastructure performance data and the process data.

93. An apparatus comprising:
a collector of process data associated with at least one information technology resource;
a collector of infrastructure performance data associated with the at least one information technology resource; and
a correlator of the infrastructure performance data and the process data for the information technology resource.

94. The apparatus as in claim 93, wherein a collector of process data further comprises:
a collector of process data from at least one software-change control system, at least one root-cause analysis system, and at least one service-level control system.

95. The apparatus as in claim 93, wherein the correlator of further comprises:
a correlator of at least one type of resource data selected from the group consisting of application resource data, server resource data and database resource data, in reference to a common data object.

96. The apparatus as in claim 93, the apparatus further comprising:
a generator of a risk score for each of the at least one information technology resource from the infrastructure performance data and the process data, wherein the magnitude of each risk score is in correspondence to the frequency of outages indicated in the infrastructure performance data and wherein the magnitude of each risk score is in correspondence to the frequency of changes in the process data, and
wherein the infrastructure performance data further comprises at least one measurement of performance and the process data further comprises at least one measurement of activity, and a generator of a risk profile further comprises:
a generator of a plurality of scores that is operable to multiply each measurement with a weighting value associated with each measurement; and
a generator of a risk score from a sum of the plurality of scores.

97. An apparatus comprising:
a collector of infrastructure data;
a collector of process data from at least one change control apparatus; and
a generator of a risk profile for each of the plurality of information technology resources, from the infrastructure data and the process data.

98. The apparatus as in claim 97, wherein the method further comprises:
a correlator of the infrastructure data and the process data, and wherein the generator of the risk profile further comprises:
a generator of the risk profile from the correlated data.

99. The apparatus as in claim 97, wherein the generator of the risk profile further comprises:
a generator of a risk score from the infrastructure data and the process data, wherein the magnitude of the risk score corresponds to the frequency of outages indicated in the infrastructure data and wherein the magnitude of the risk score corresponds to the frequency of changes in the process data, for each of the plurality of information technology resources.

100. The apparatus as in claim 97, wherein the infrastructure data further comprises at least one measurement of performance for each of the plurality of information technology resources and the process data further comprises at least one measurement of activity for each of the plurality of information technology resources, and a generator of a risk profile further comprises:
a multiplier of the at least one measurement to a weighting value associated with each measurement, yielding at least one score; and
an adder of the at least one score, yielding a risk score.

101. A system to manage outages of information technology resources, the system comprising:
means for collecting infrastructure performance data from at least one automated testing tool, wherein the infrastructure performance data further comprises at least one of application performance data, server error logs, application post mortem data, and outage data;
means for collecting process data from at least one of a one service-level control system, a change control system, a root-cause analysis system;
means for correlating the infrastructure performance data and the process data; and
means for generating a risk profile for each of the information technology resources from a frequency of outages in the correlated data and a frequency of changes in the correlated data.

102. The system as in claim 101, wherein the correlating means further comprises:
means for correlating application data, server data and database data from the infrastructure performance data and the process data.

103. The system as in claim 101, wherein the means for correlating further comprises:
means for correlating the infrastructure performance data and the process data for each of the information technology resources, in reference to organizational control of the resources.

104. The system as in claim 101, wherein the infrastructure performance data further comprises at least one measurement of performance for an information technology resource and the process data further comprises at least one measurement of activity for the information technology resource, and the means for generating a risk profile further comprises:
means for generating a score for each of the measurements, each measurement being multiplied by a weighting value associated with each measurement, yielding a plurality of scores; and
means for summing the plurality of scores, yielding a risk score.

105. The system as in claim 104, wherein the means for generating a score for each of the measurements further comprises:
means for generating the score with a higher magnitude for an increasing frequency of outages of the information technology resource as indicated in the infrastructure performance data;
means for generating the score with a higher magnitude for an increasing frequency of changes of the information technology resource as indicated in the process data;
means for generating the score with a lower magnitude for a decreasing frequency of outages of the information technology resource as indicated in the infrastructure performance data; and
means for generating the score with a lower magnitude for a decreasing frequency of changes of the information technology resource as indicated in the process data.

106. A system to predict outages of an information technology resource, the system comprising:
means for generating a singular risk score from infrastructure performance data of the information technology resource and process data of the information technology resource; and
means for providing an alert to a user when the singular risk score exceeds a predetermined threshold.

107. The system as in claim 106, wherein the means for generating a singular risk score further comprises:
means for generating the singular risk score in correspondence to the frequency of outages indicated in the infrastructure performance data and in correspondence to the frequency of changes in the process data.

108. The system as in claim 106, wherein the infrastructure performance data further comprises at least one measurement of performance and the process data further comprises at least one measurement of activity, and the means for generating a singular risk score further comprises:
means for generating a singular score for each of the measurements, each measurement being multiplied by a weighting value associated with each measurement, yielding a plurality of weighted scores; and
means for summing the plurality of weighted scores, yielding the singular risk score.

109. The system as in claim 106, the system further comprising:
means for collecting (304) the process data (208) from at least one manual-work-process tracking system;
means for collecting the infrastructure performance data; and
means for correlating the infrastructure performance data and the process data.

110. The system as in claim 109, wherein collecting process data from at least one manual-work-process tracking system further comprises:
means for collecting process data from at least one change control system; and
means for collecting infrastructure performance data from at least one automated testing tool, and wherein the infrastructure performance data further comprises at least one of application performance data, server error logs, application post mortem data, and outage data.

111. A system to manage data that is predictive of reliability of an information technology system, the system comprising:
means for collecting process data associated with at least one information technology resource;
means for collecting infrastructure performance data associated with the at least one information technology resource; and
means for correlating the infrastructure performance data and the process data for the information technology resource.

112. The system as in claim 111, wherein the means for collecting infrastructure performance data further comprises:
means for collecting infrastructure performance data from at least one automated testing tool, wherein the infrastructure performance data further comprises at least one of application performance data, server error logs, application post mortem data, and outage data, and
wherein the means for collecting process data further comprises:
means for collecting process data from at least one software-change control system, at least one root-cause analysis system, and at least one service-level control system.

113. The system as in claim 111, wherein the means for correlating further comprises:
means for correlating application data, server data and database data from the infrastructure performance data and the process data, for the at least one information technology resource, and in reference to organizational control of the resource.

114. The system as in claim 111, wherein the means for correlating further comprises:
means for correlating at least one type of resource data selected from the group consisting of application resource data, server resource data and database resource data, in reference to a common data object.

115. The system as in claim 111, the system further comprises:
means for generating a risk score for each of the at least one information technology resource from the infrastructure performance data and the process data, wherein the magnitude of each risk score is in correspondence to the frequency of outages indicated in the infrastructure performance data and wherein the magnitude of each risk score is in correspondence to the frequency of changes in the process data.

116. The system as in claim 115, wherein the infrastructure performance data further comprises at least one measurement of performance and the process data further comprises at least one measurement of activity, and the means for generating a risk profile further comprises:
means for generating a plurality of scores by multiplying each measurement with a weighting value associated with each measurement; and
means for generating a risk score from a sum of the plurality of scores.

117. A system to assess reliability of a plurality of information technology resources, the system comprising:
means for collecting infrastructure data;
means for collecting process data from at least one change control system; and
means for generating a risk profile for each of the plurality of information technology resources, from the infrastructure data and the process data.

118. The system as in claim 117, wherein the means for collecting infrastructure data further comprises:
means for collecting infrastructure data from at least one automated testing tool.

119. The system as in claim 117, wherein the system further comprises:
means for correlating the infrastructure data and the process data, and the means for generating a risk profile further comprises:
means for generating a risk profile from the correlated data.

120. The system as in claim 117, wherein the means for generating a risk profile further comprises:
means for generating a risk score from the infrastructure data and the process data, wherein the magnitude of the risk score corresponds to the frequency of outages indicated in the infrastructure data and wherein the magnitude of the risk score corresponds to the frequency of changes in the process data, for each of the plurality of information technology resources.

121. The system as in claim 117, wherein the infrastructure data further comprises at least one measurement of performance for each of the plurality of information technology resources and the process data further comprises at least one measurement of activity for each of the plurality of information technology resources, and the means for generating a risk profile further comprises:
means for generating a score for each of the at least one measurement, each measurement being multiplied by a weighting value associated with each measurement, yielding at least one score; and
means for adding the at least one score, yielding a risk score.

122. A computer-accessible medium having executable instructions to manage outages of information technology resources, the executable instructions capable of directing a processor to perform:
identifying measurements in infrastructure data and process data that are indicative of failure rates of information technology resources;
determining significance of each of the measurements; and
modifying a method for calculating risk from the significance.

123. The computer-accessible medium as in claim 122, wherein the method is performed periodically in order to heuristically update failure prediction analysis.

124. The computer-accessible medium as in claim 122, wherein the method for calculating risk further comprises:
generating a score for each of the measurements, each measurement being multiplied by a weighting value associated with each measurement, yielding a plurality of scores; and
summing the plurality of scores, yielding a risk score.
